(19) United States
(12) Patent Application Publication
(10) Pub. No.: US 2005/0226192 A1
(43) Pub. Date: Oct. 13, 2005

(54) Systems and methods for controlling and monitoring multiple electronic devices

(76) Inventors: Walter E. Red, Provo, UT (US); Michael S. Baxter, Hillsboro, OR (US); Daniel J. Thompson, Redmond, WA (US)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/823,465

(22) Filed: Apr. 13, 2004

(51) Int. Cl. H04L 12/28; H04Q 7/24; G06F 13/40; G06F 15/16; H04L 12/56

(52) U.S. Cl. 370/338; 370/425; 709/209

(57) ABSTRACT

A device control system for controlling multiple electronic devices over a network with a centralized host device is disclosed. The device control system includes a host device providing a graphical interface for a user to control various electronic devices throughout a home, building, or industrial plant. The host device is connected to multiple devices over a network and controls the electronic devices in real-time. The host device runs a managing controlling process that closes the control loops for each device over the network at the host device. Multiple devices are controlled in real-time using a 2^{N} time slicing algorithm. The host device can be accessed from a remote location by establishing an Internet connection.

### TECHNICAL FIELD

The present invention relates generally to centralized control of electronic devices. More specifically, the present invention relates to systems and methods for providing real-time control of multiple electronic devices by a centralized computing platform.

### BACKGROUND

Computer and communication technologies continue to advance at a rapid pace. Indeed, computer and communication technologies are involved in many aspects of a person's day. For example, many devices being used today by consumers have a small computer incorporated within the device. These small computers come in varying sizes and degrees of sophistication. These small computers may vary in sophistication from one microcontroller to a fully-functional complete computer system. For example, small computers may be a one-chip computer, such as a microcontroller, a one-board type of computer, such as a controller, or a typical desktop computer, such as an IBM-PC compatible, etc.

Typically, control of these devices occurs locally at the device with the incorporated computer or microcontroller. Therefore, control of multiple electronic devices in a residential or industrial setting has been distributed. Control and coordination of each device is usually implemented in dedicated, single purpose hardware. Each device typically has its own microcontroller, programmable logic controller, or servo card to perform the necessary servo control. Consequently, the control loops are typically closed in the control hardware at the device itself.

As electronic device control technologies continue to advance in a competitive environment, companies are driven to differentiate their product lines. As a result, some user interfaces of electronic devices have become increasingly complex. This has resulted in an inundation of complex interfaces for devices that have limited coordination with one another. For example, it is not uncommon for a typical entertainment system to have five different wireless remote control devices: one for the television, one for the VCR, one for the DVD player, one for the CD changer, and one for the stereo.

Consequently, it would be desirable to have centralized, instead of distributed control of these automated devices. It would further be desirable to provide a simple and straightforward user interface that can be used to control devices from a centralized location.

### BRIEF DESCRIPTION OF THE DRAWINGS

The present embodiments will become more fully apparent from the following description and appended claims, taken in conjunction with the accompanying drawings. Understanding that these drawings depict only typical embodiments and are, therefore, not to be considered limiting of the invention's scope, the embodiments will be described with additional specificity and detail through use of the accompanying drawings in which:

FIG. 1 is a block diagram illustrating the main hardware components of one embodiment of the device control system;

FIG. 2 is a block diagram illustrating one example of a managing controller process in a host device of the system;

FIG. 3 is a block diagram depicting a control loop process that occurs between the host device and a controlled device;

FIG. 4 is a block diagram illustrating the main hardware components of an alternative embodiment of the device control system;

FIG. 5 is a block diagram illustrating a host device communicating with a controlled device over a wireless network;

FIG. 6 is a block diagram illustrating the major hardware components typically utilized in a host device;

FIG. 7 is a block diagram illustrating the major hardware control components typically utilized in a controlled device to communicate and respond to input from the host device;

FIG. 8 is a block diagram depicting the hardware control components of a controlled device having a motor;

FIG. 9 is a flow diagram of one embodiment of a method for processing multiple control loops within the managing controller process;

FIG. 10 is a flow diagram of a method for processing a single control loop within the managing controller process for one controlled device;

FIG. 11 is a flow diagram of a method for processing within a controlled device, a control loop initiated by the host device;

FIG. 12 is a flow diagram of a method for allowing user access to the managing controller process; and

FIG. 13 is a flow diagram of one embodiment of a method for providing user access to the managing controller process from a remote computing device.

### DETAILED DESCRIPTION

A method for controlling electronic devices through a centralized host device is disclosed. In the method, electronic communications are established between the host device and a controlled device. A control frequency is assigned for the controlled device using a 2^{N} time slicing algorithm, where N is a non-negative integer. Control input for the controlled device is generated at the host device and sent to the controlled device at the assigned control frequency.

Once electronic communications are established with the controlled device, the host device may initiate a control loop process. The host device may also receive output from the controlled device which is generated in response to sent control input. Further, the electronic communications between the host and the controlled devices may be in real-time on a network.

The 2^{N} time slicing algorithm may include assigning the control frequency for the controlled device at 2^{N} hertz, where N is a non-negative integer that yields a control frequency approximate to the preferred control frequency of the controlled device. In certain embodiments, real-time electronic communications may be established between multiple electronic devices and the host device. Each controlled device is assigned a discrete control frequency using the 2^{N} time slicing algorithm where the N value for each controlled device is determined independent of the other controlled devices.

The method may further include accessing the host device from a remote computing device via the Internet. Information relating to the controlled device may then be provided to the user at the remote computing device. The user may then generate and send input to the host device from the remote computing device. The input may relate to the control or monitoring of the controlled device.

A computing device configured for controlling electronic devices is also provided. The computing device includes a processor and memory in electronic communications with the processor. The computing device also includes executable instructions that can be executed by the processor. The executable instructions are configured to establish electronic communications between the computing device and one or more controlled devices. The executable instructions are also configured to assign a control frequency to each controlled device using a 2^{N} time slicing algorithm where N is a non-negative integer. Control input is then generated and sent to the controlled device at the assigned control frequency.

A computer-readable medium for storing program data is provided as well. The program data includes executable instructions for implementing a method of controlling electronic devices from a computing device. In the method, electronic communications are established between the computing device and a controlled device. A control frequency is assigned for the controlled device using a 2^{N} time slicing algorithm, where N is a non-negative integer. Control input for the controlled device is generated at the computing device and sent to the controlled device at the assigned control frequency.

It will be readily understood that the components of the embodiments as generally described and illustrated in the Figures herein could be arranged and designed in a wide variety of different configurations. Thus, the following more detailed description of the embodiments of the systems and methods of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Several aspects of the embodiments described herein will be illustrated as software modules or components stored in a computing device. As used herein, a software module or component may include any type of computer instruction or computer executable code located within a memory device and/or transmitted as electronic signals over a system bus or network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction, or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

Note that the exemplary embodiment is provided as an exemplar throughout this discussion, however, alternate embodiments may incorporate various aspects without departing from the scope of the present invention.

The order of the steps or actions of the methods described in connection with the embodiments disclosed herein may be changed by those skilled in the art without departing from the scope of the present invention. Thus, any order in the Figures or detailed description is for illustrative purposes only and is not meant to imply a required order.

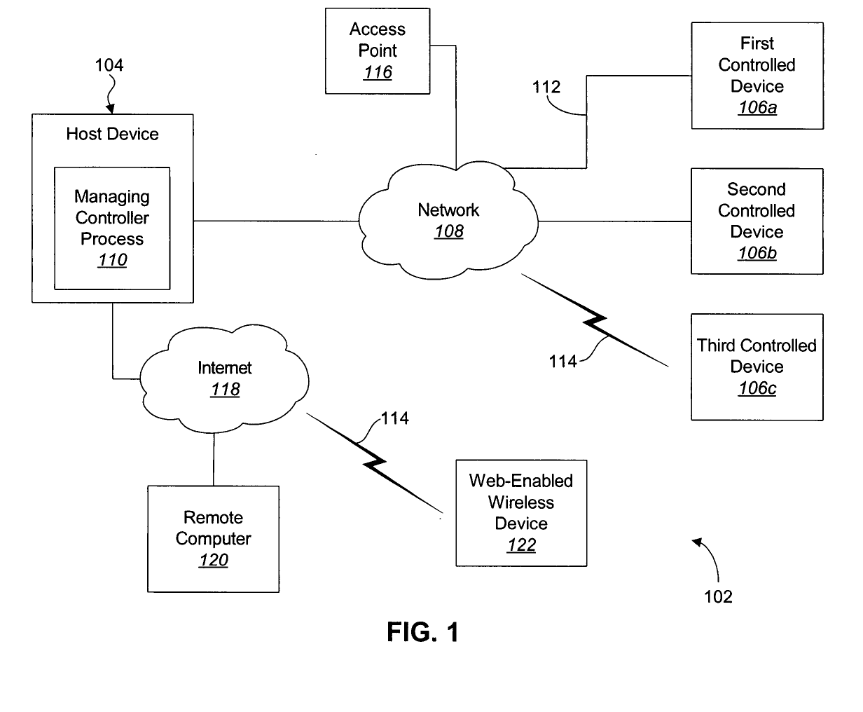

FIG. 1 is a block diagram illustrating the major components of one embodiment of the device control system 102. The device control system 102 of FIG. 1 includes a host device 104 that is in electronic communication with three controlled electronic devices 106a, 106b, 106c via a communications network 108. The device control system 102 may alternatively be in communication with greater than or fewer than the three controlled devices 106a, 106b, 106c illustrated.

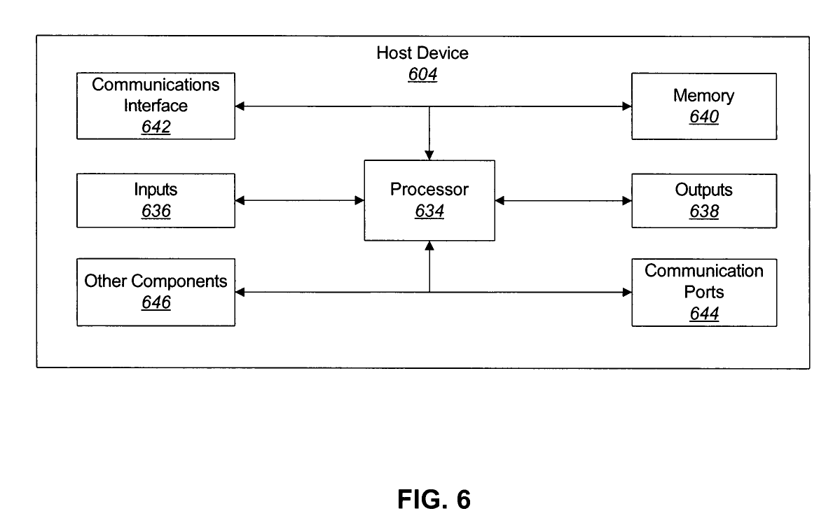

The host device 104 may be one of any number of computing devices such as a Personal Computer (PC), tablet PC, or Personal Digital Assistant (PDA) device having an operating system that can run or support real-time applications for over the network servo control. Furthermore, more than one host device 104 may be utilized in the present system 102. The major hardware components of the host device 104 will be described with greater detail and specificity in conjunction with the description accompanying FIG. 6. The host device 104 includes a managing controller process 110 to manage and execute the control loops for the controlled devices 106a, 106b, 106c simultaneously. Control loops generally include the generation of control input, such as a command parameter, the processing of the control input by the designated controlled device 106, generation of outputs such as feedback at the controlled device 106, and the processing of the device outputs. The managing controller process 110 is a software module or application that runs on the host device 104.

The controlled devices 106a, 106b, 106c may be one of any number of electronic devices such as motors, actuators, and sensors associated with residential or industrial devices. For example, in a residential device control system 102, the controlled devices 106a, 106b, 106c may include typical residential devices and systems such as washing machines, clothes dryers, refrigerators, microwave ovens, conventional gas or electric ovens, telephone systems, security systems, sprinkler systems, Heating, Ventilation, & Air Conditioning (HVAC) systems, dishwashers, lighting systems, sound systems, television and home theater systems, and many other similar devices.

Alternatively, the device control system 102 may control industrial devices used in chemical processing systems, material handling, and motion systems for use on devices such as machine tools, robots, conveyors, and the like. Additionally, complicated industrial and commercial HVAC systems that utilize many actuators, motors, switches and sensors can all be controlled through the host device 104 of the device control system 102.

Unlike the distributed control of many conventional automated devices, the device control system 102 has a centralized control architecture. The term centralized does not mean that all control must occur at a single location, as there may be more than one host device. Centralized control may be contrasted from distributed control in that centralized control may put control in one or a few devices, while distributed control has control functions distributed on all, or many devices.

The managing controller process 110 of the host device 104 provides the control input to perform the controlling functions of the controlled devices 106a, 106b, 106c that are traditionally performed by programmable logic controllers, microcontrollers, and related hardware. In conventional systems, the control loops are customarily closed in control hardware at the electronic device itself. The only closing of control loops over the network that usually occurs in conventional systems is to obtain status and deliver settings, which are not accomplished in real-time. In the present embodiment, a portion of the control hardware for traditional automated devices is typically replaced with control software (the managing controller process 110) on a centralized host device 104. Each control loop associated with a particular controlled device 106a, 106b, 106c is closed in software over the network 108 from the host device 104.

The host device 104 communicates with the controlled devices 106a, 106b, 106c over a computer network 108. In certain embodiments the computer network 108 may be a high-speed network. An exemplary high-speed network 108 that may be used is an Ethernet system. The network 108 may be a physical transportation medium 112 such as twisted pair wires, cables, or fiber optics. The network 108 may also include wireless links 114, or a combination of physical 112 and wireless mediums 114. Any transportation medium capable of delivering and receiving command signals and feedback signals to and from the controlled devices 106a, 106b, 106c would be sufficient as long as the network can perform in an isochronous (fixed frequency) mode.

Furthermore, the device control system 102 may include additional access points 116 such as a touch-screen Liquid Crystal Display (LCD) panel, conventional PC and monitor, or similar graphical interfaces. Additional access points 116 would enable a user to access the device control system 102 from a different location in the house, industrial plant, or building. A user can thereby program or monitor the managing controller process 110 at several locations. Access points 116 may optionally be located on the device itself, to control the controlled device 106 locally if desired. Each access point 116 is connected to the host device 104 through the network 108.

Exemplary graphical interfaces provided by the host device 104 and the additional access points 116 may be web-enabled browser applications. Browser applications possess the advantages of networking and communication of data, but also support common applications that can be used to facilitate user interactions, such as the Flash interface application.

Typically the controlled devices 106a, 106b, 106c would not have direct connections to the Internet 118 which could provide the user with access to the World Wide Web directly from the controlled device 106. The device control system 102 has a centralized control system through a local network 108 to provide real-time process control not available through an Internet connection. Thus, in embodiments herein a user may access the host device 104 through the Internet 118, and the host device 104 communicates with the controlled devices 106 through the computer network 108.

The host device 104 of the device control system 102 may be accessed by a user from a location remote from where the device control system 102 is located. According to the embodiment depicted in FIG. 1, the host device 104 is connected to the Internet 118, which in turn may be accessed from any location around the world. The user may log-on to the device control system 102 from a remote computer 120 or similar web-enabled computing device, to program or monitor the controlled devices 106a, 106b, 106c on the system. The user may alternatively use a web-enabled wireless device 122 such as a cell phone or wireless PDA to access the host device 104. The wireless signal 114 is transmitted to a cellular service provider which is then connected to the Internet. Therefore, from a remote computer or a cellular phone, a residential user could arm the security system or program the lighting system of his home to deter potential burglaries while away on vacation. Alternatively, a parent could unlock the doors to his home from work when his children are locked out.

Furthermore, in cooperation with public utilities, the device control system 102 may be configured to establish a secure interface with utility companies through the Internet 118. The host device 104 could be connected to water, gas, and electric meters through a secure network 108 connection to interface with and electrically monitor each utility. At a specific time of the month, the host device 104 would query the secure interfaces, obtain data indicating the amount of the utility used, and then automatically mail the data to the public utility over the Internet 118, thus eliminating the need for manual inspection by utility employees. Algorithms could also be incorporated into the managing controller process 110 to alert the home or business owner at the device control system 102 interface of over-usage of utility resources.

The centralized control architecture provided by the device control system 102 provides for flexibility in defining and altering the managing controller process 110 through software modification instead of hardware upgrade and replacement for each individualized controlled device 106a, 106b, 106c. Since the host device 104 is connected to the Internet 118, a new control process for an existing device or for a new device could be downloaded over the Internet 118. The downloading process could be automated and occur without initiation by the user. In such situations the host device 104 will automatically download new control processes and inform the user that a new process is ready to be installed. Upon user consent, the new process will be installed for the device, along with its associated monitoring and scheduling interface.

The control and interface software for the centralized control architecture of the device control system 102 is typically developed in a standard programming environment that currently exists on a PC, or the computing device used as a host device 104. Consequently, device control software upgrades and new installations will all be uniform for the device control system 102. Conventionally, when developing software for custom computing hardware devices, a unique language or a variant of an existing language may be used. Functional restrictions in conventional device control hardware may also act as limitations. For example, mathematical imprecision is usually taken into account when using an 8-bit computer, but is not as relevant when dealing when modern 32-bit or 64-bit computing devices. As a result, writing software for new process systems or upgrades is facilitated through the use of the device control system 102.

Furthermore, the centralized control architecture of the device control system 102 also eliminates the need for distributed computing hardware such as most microcontrollers, programmable logic controllers, PC servo control cards, or peripheral servo controllers associated with controlled devices 106a, 106b, 106c. The controlled devices 106a, 106b, 106c are instead connected to and controlled directly by the host device 104. Replacing device computing hardware with software on the host device 104 will diminish costs. Furthermore, the programming interfaces, control wiring and power electronics of the controlled devices 106a, 106b, 106c are simplified as a result of the device control system 102.

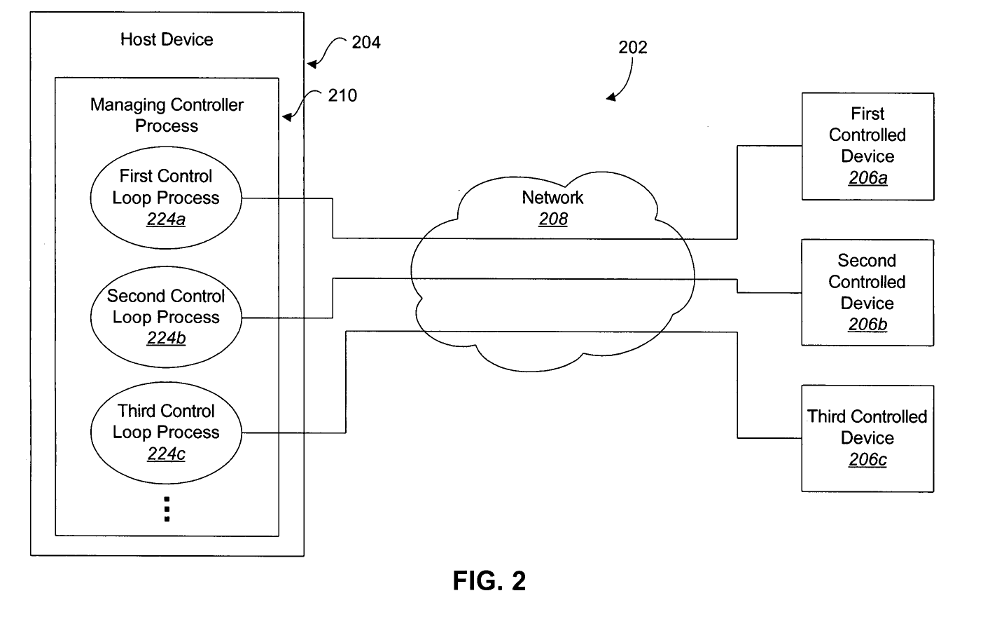

FIG. 2 is a block diagram illustrating one example of a managing controller process 210 in a host device 204 of a device control system 202. The managing controller process 210 provides an interface with the user to monitor or program device control. The managing controller process 210 also is the real-time control process that runs on the host device 204 and communicates the control parameters over the network 208 to each controlled device 206a, 206b, 206c. The managing controller process 210 runs individual control loop processes 224a, 224b, 224c for each controlled device 206a, 206b, 206c at a specified control frequency required for each specific device.

As graphically illustrated in the block diagram of FIG. 2, a first control loop process 224a runs as a part of the managing controller process 210 at a specified control frequency to provide command parameters and receive feedback from the first controlled device 206a. Simultaneously, a second control loop process 224b runs as a part of the managing controller process 210 at a specified control frequency to control and monitor the second controlled device 206b. A third control loop process 224c also runs simultaneously as a part of the managing controller process 210 at a specified control frequency to provide control input and receive and process device output of the third controlled device 206c. Additional control loop processes 224 may run as a part of the managing controller process 210 if additional controlled devices 206 are added on the device control system 202.

The control frequency of the first control loop process 224a may be different from the control frequency of the second control loop process 224b, and likewise the third control loop process 224c. For example, a motor may need to operate at a control frequency of 1000 cycles per second (hertz—Hz). Simultaneously, a thermostat may only need to operate at a control frequency of 2 Hz. While a washing machine will need to cycle at about 100 Hz. Each of these process cycles is run in real-time. Consequently, the managing controller process 210 is designed to control different device types, each demanding a different control frequency, in real-time. The processing power of the host device 204 runs the control loops 224a, 224b, 224c sufficiently fast to control the controlled devices 206.

By pulling the control loop processes into the host device 204, the need for custom computing hardware on the controlled devices 206a, 206b, 206c is eliminated. Furthermore, additional control algorithms could be used with this centralized control architecture. For example, an algorithm could be developed to detect degradation in component performance of a controlled device 206 and alert the user that the device needs to be serviced before it breaks down. In the context of HVAC systems, this algorithm, run as a part of the managing controller process 210, could be used to detect whether a motor is drawing more current than it should. The system could also detect whether a furnace is consuming more electricity than it should due to the increased work of pushing air through a dirty filter. The user is then notified at the graphical interface to replace the filter. Such a system would provide a user with great savings compared to conventional device control.

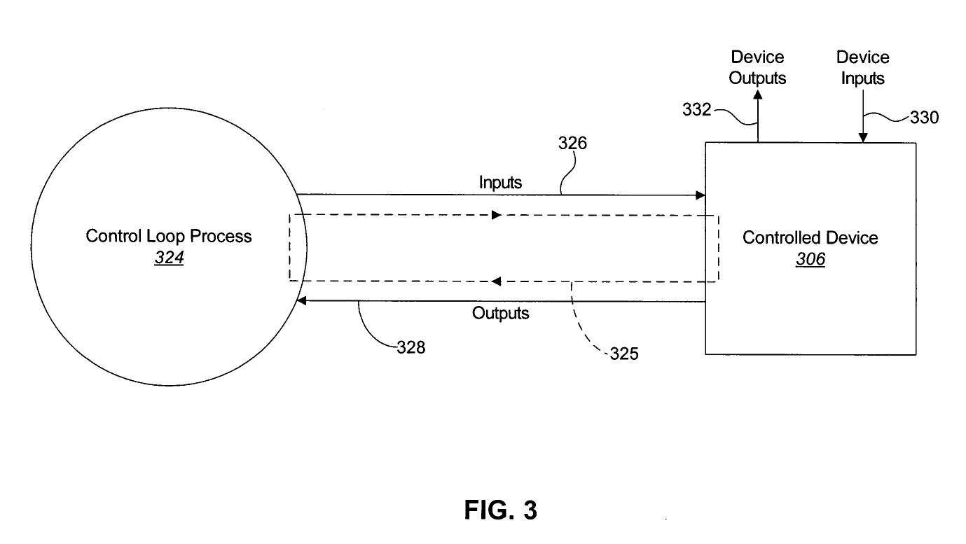

FIG. 3 is a block diagram depicting a single control loop process 324 occurring at a host device (not shown) which controls a controlled device 306 at a specific control frequency. The control loop process 324 that occurs at the host device creates a control loop 325 between the host device and the controlled device 306. The control loop 325 generally constitutes the generation of control input 326, such as a command parameter, at the host device. The control input 326 may be any input that can be used by the controlled device. The control input 326 is transmitted to the controlled device 306 via the network (not shown). The controlled device 306 receives and processes the control input 326. In a closed-loop system, as illustrated in FIG. 3, the controlled device 306 generates an output 328, such as a feedback signal, which is transmitted to the host device over the network. The outputs 328 may be any output provided by or generated by the device 306. The control loop process 324 of the host device then processes the controlled device outputs 328, thereby completing one cycle of the control loop 325.

Typically the host device is situated in close proximity to the controlled device 306. The maximum allowable distance between the host device and the controlled device 306 is dependent upon the cycle time to close the control loop 325 between the controlled device 306 and the host device. This will be a function of the high speed network type and the control frequency required for the controlled device 306. That is, for real-time device control, the time it takes to transmit data over the distance between the host device and the controlled device 306 needs to be fast enough to meet the real-time constraints of the system.

The controlled device 306 may optionally receive device inputs 330 from a source separate from the host device. For example, the controlled device 306 may also include buttons, on/off switches, or an LCD touch-screen display for a user to control the device locally. Alternatively, the device may include sensors or other input sources that are not part of the device control system. The controlled device 306 may also optionally produce device outputs 332 that are not transmitted to the host device. Indicator lights, speakers, or similar systems may act upon receiving device output 332.

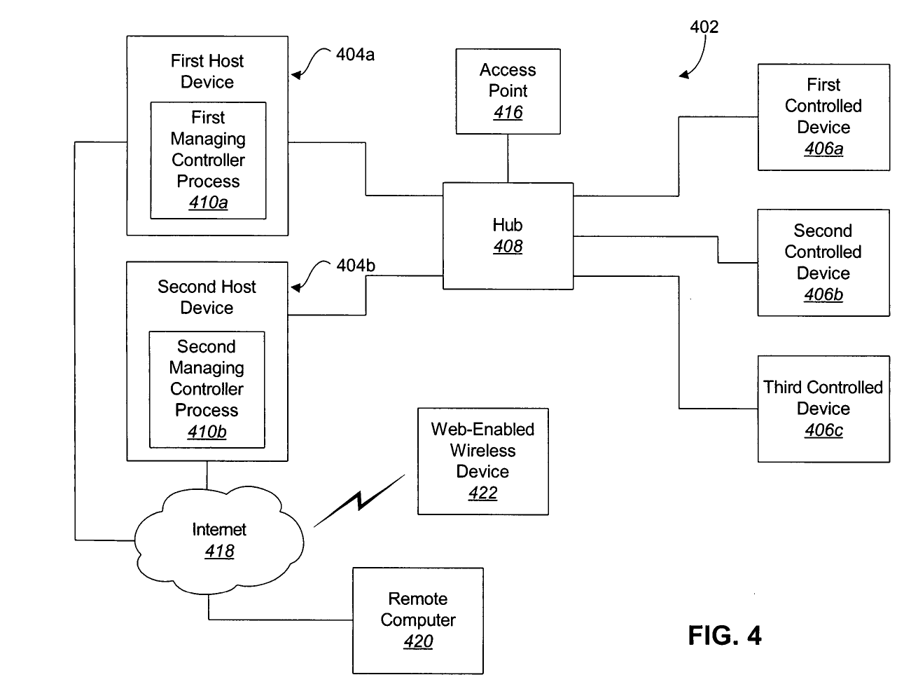

FIG. 4 is a block diagram illustrating the major components of an alternative embodiment of the device control system 402. The device control system 402 is able to control multiple controlled devices 406a, 406b, 406c through first and second host devices 404a, 404b. More than two host devices 404a, 404b may be utilized if needed, depending upon the number and complexity of the devices that need to be controlled, and the processing power of each host device 404a, 404b. Each host device 404a, 404b runs a managing controller process 410a, 410b, which operates the individual control loops for each controlled device 406a, 406b, 406c.

All local components of the device control system 402 are connected to the network hub 408. The hub 408 contains multiple ports for receiving connections for the first and second host devices 404a, 404b, the first, second, and third, controlled devices 406a, 406b, 406c, and the additional access point 416 which provides an additional graphical interface for a user to operate and monitor the device control system 402 from an alternative location. The hub 408 may be used as part of an Ethernet or other high-speed network in connecting all peripheral devices to the host devices 404a, 404b. One proposed network media for use with the device control system 402 is IEEE 802.3 Ethernet which has been restricted in its application protocol for real-time communications.

Furthermore, like the embodiment of the system described in conjunction with FIG. 1, the first and second host devices 404a, 404b of the device control system 402 are connected to the Internet 418 to allow downloads of new control process software or software updates. The Internet 418 connection also allows a user remote access to the device control system 402 from a remote computer 420 or a web-enabled wireless device 422.

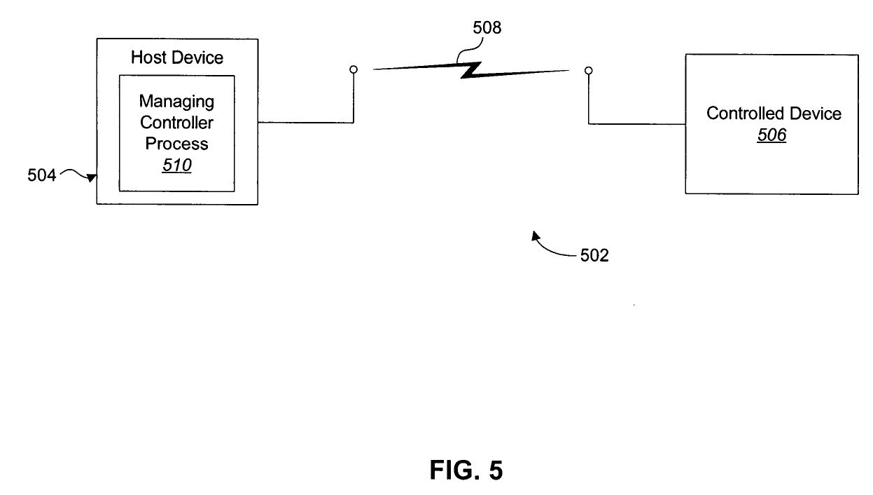

FIG. 5 is a block diagram illustrating a device control system 502 with a host device 504 communicating with a controlled device 506 over a wireless network 508. The host device 504 hosts the managing controller process 510 which runs the individual process control loops for each controlled device 506. In the embodiment of FIG. 5 the control loop between the host device 504 and the controlled device 506 occurs over a wireless network or connection 508. The wireless transmissions typically operate in the Radio Frequency (RF) spectrum, but could alternatively operate in the microwave or infrared spectrum, or any other operable frequency range or any other alternative forms of wireless communication known in the art such as ultrasonic. Both the host device 504 and the controlled device 506 may includes a wireless card to communicate with each other, or a more rudimentary transmitter/receiver system or similar wireless devices known in the art.

FIG. 6 is a block diagram illustrating the major hardware components typically utilized in a host device 604. As mentioned previously, the host device 604 is a computing device such as a PC, tablet PC, or PDA device capable of running real-time applications. For example, Windows XP may run on the host device 604 to serve the user interfaces and network browsers. Windows XP may also run a real-time operating system such as QNX, which runs as a kernel process within Windows XP. VenturCom and others also have real-time applications that can run similarly.

For purposes of FIG. 6, the term “host device” and “computing device” are used synonymously. Computing devices 604 are known in the art and are commercially available. The major hardware components typically utilized in a computing device 604 are illustrated in FIG. 6. A computing device 604 typically includes a processor 634 in electronic communication with input components or devices 636 and/or output components or devices 638. The processor 634 is operably connected to input 636 and/or output devices 638 capable of electronic communication with the processor 634, or, in other words, to devices capable of input and/or output in the form of an electrical signal. Embodiments of devices 604 may include the inputs 636, outputs 638 and the processor 634 within the same physical structure or in separate housings or structures.

The electronic device 604 may also include memory 640. The memory 640 may be a separate component from the processor 634, or it may be on-board memory 640 included in the same part as the processor 634. For example, microcontrollers often include a certain amount of on-board memory.

The processor 634 is also in electronic communication with a communication interface 642. The communication interface 642 may be used for communications with other computing devices, controlled devices, servers, etc. Thus, the communication interfaces 642 of the various devices may be designed to communicate with each other to send signals or messages between the computing device 604 and other devices.

The computing device 604 may also include other communication ports 644. In addition, other components 646 may also be included in the computing device 604.

Of course, those skilled in the art will appreciate the many kinds of different devices that may be used with embodiments herein. The computing device 604 may be a one-board type of computer, such as a controller, a typical desktop computer, such as an IBM-PC compatible, a PDA, a Unix-based workstation, or any other available computing device that is capable of operating real-time control processes. Accordingly, the block diagram of FIG. 6 is only meant to illustrate typical components of a computing device 604 and is not meant to limit the scope of embodiments disclosed herein.

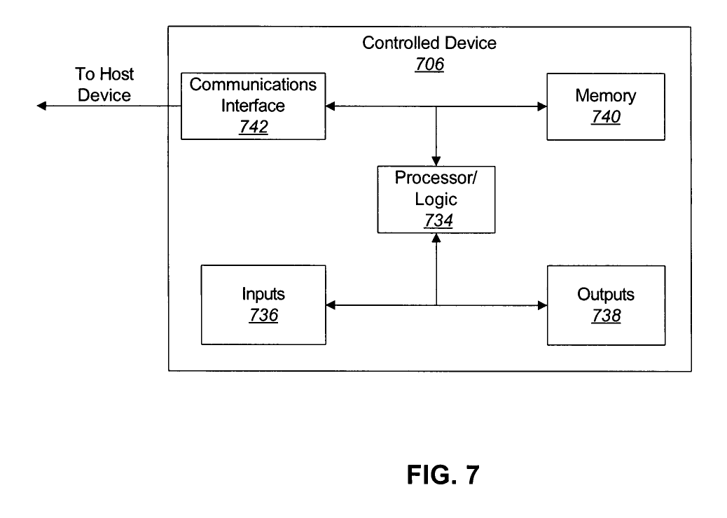

FIG. 7 is a block diagram illustrating the major hardware control components typically utilized in a controlled device 706 in order to communicate and respond to input from the host device. The controlled device 706 may include simple control logic 734 or a processor in electronic communication with a communication interface 742. The communication interface 742 is used for communications with the host device. Thus, the communication interfaces 742 of the controlled device 706 may be designed to communicate with the host device by sending signals or messages between each other. In some situations the controlled device 706 only sends a signal to the host device when instructed to do so by the host device.

The controlled device 706 may also be in electronic communication with input components or devices 736 and/or output components or devices 738. The logic/processor 734 is operably connected to input 736 and/or output devices 738 capable of electronic communication with the processor 734, or, in other words, to devices capable of input and/or output in the form of an electrical signal. Input devices 736 may include such control buttons or switches for a user to actuate or external or internal sensors such as temperature or pressure sensors. Output devices 738 could be indicator lights, LCD display screens, and the like. The controlled device 706 itself, such as a motor, HVAC system, or dishwasher, would also receive the electronic output signals from the hardware control components to operate in accordance with the parameters sent by the host device.

The hardware control components of the controlled device 706 may also include memory 740. The memory 740 may be a separate component from the logic/processor 734, or it may be on-board memory 740 included in the same part as the processor 734. For example, microcontrollers often include a certain amount of on-board memory.

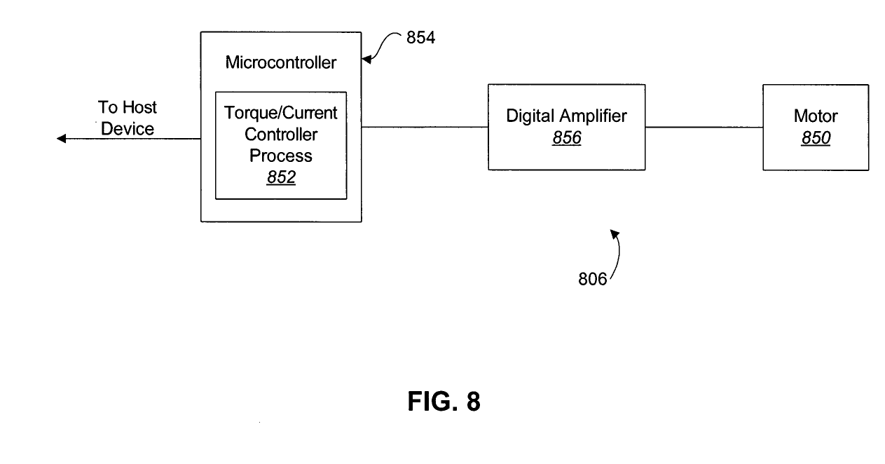

FIG. 8 is a block diagram depicting the hardware control components of an embodiment of a controlled device 806 being used in combination with a digital amplifier 856 and a motor 850. There may be some control loops that are preferably closed in hardware at the controlled device 806. For example, the current/torque control loop needed to control a motor 850 is closed at the controlled device 806. The control hardware needed for the current/torque control loop process 852 is a microcontroller 854 and a digital amplifier 856.

The motor 850 provides mechanical movement for the controlled device 806; the digital amplifier 856 modulates motor power; and the microcontroller 854 is used to communicate digital control commands over the network. The microcontroller 854 interprets commands received from the host device and passes the digital control parameters to and from the amplifier 856 accordingly. The microcontroller 854 is not a conventional microcontroller since it only serves to pass digital data.

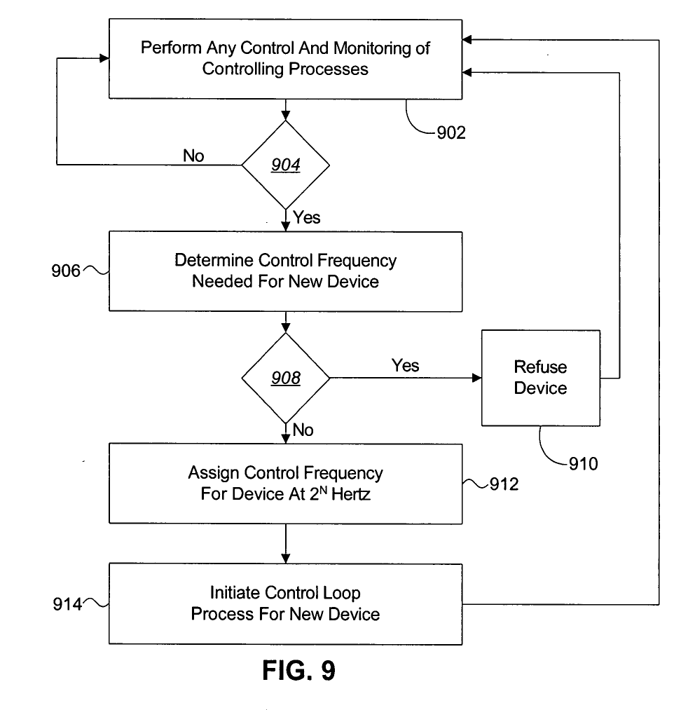

FIG. 9 is a flow diagram of one embodiment of a method for processing multiple control loops within the managing controller process 110. The managing controller process 110 performs 902 any control and monitoring of control loop processes currently running. The functions of the managing controller process and each control loop for a particular controlled device are described in detail in conjunction with FIGS. 2 and 3, respectively. For instance, if an HVAC system is operating, the managing controller process is performing control loop processes for the thermostats, furnace motors or condenser coil fan motors, compressors and the like.

As the managing controller process 110 operates, it 110 determines 904 whether a new controlled device has been connected to the device control system network. The device control system will recognize new controlled devices when they are connected to the network without having to restart the host device. Moreover, controlled devices currently running on the device control system can be disconnected from the network without having to restart the host device. This ability to hot-swap controlled devices enables devices to be added or removed randomly from the device control system network.

A negative response to the query 904 whether a new controlled device has been connected will cause the managing controller process to continue performing 902 any control and monitoring of control loop processes currently running. However, if a positive response to the new device query 904 is received because a new controlled device has been connected to the network, the managing controller process determines 906 the control frequency needed for the new controlled device.

Each controlled device operates at a specific control frequency or duty cycle. The control frequency of one controlled device is often different from the control frequency of another device. As mentioned previously, the control frequency of a motor may be at about 1000 Hz, while a washing machine operates at a control frequency of about 100 Hz, and a thermostat might operate at a control frequency of about 2 Hz.

Once the control frequency of the new controlled device is determined, the managing controller process must then determine 908 whether the sum of all control frequencies exceeds the bandwidth. In order for all the controlled devices to operate in real-time while running on the device control system network, the sum of all the control frequencies for each device cannot exceed the bandwidth of the device control system. For example, given a bandwidth of 5 kHz, if four motors were running at a control frequency of about 1 kHz each, along with a washing machine operating at 100 Hz, the devices could continue to run in real-time because 4100 Hz<5 kHz. However, if a new controlled device having a motor that requires 1 kHz is connected to the device control system, the sum of all control frequencies of the controlled devices is 5100 Hz, which exceeds the bandwidth (5 kHz).

If the query 908 whether adding the new device will exceed the bandwidth is answered positively, the new controlled device is refused 910 from operating on the device control system in order to preserve real-time communication. The managing controller process will subsequently continue to control and monitor 902 the control loop processes of existing controlled devices that operate at control frequencies that do not exceed the bandwidth.

However, in the more likely event that the query 908 whether adding the new device will exceed the bandwidth is answered negatively, a control frequency is assigned 912 for the controlled device using a 2^{N} time slicing algorithm. A control loop process for the new controlled device is assigned a specific, discrete control frequency defined by the 2^{N} algorithm, where N is an integer that defines the control resolution (a larger N value increases the control resolution).

For example, given a control bandwidth F of 5 kHz, the managing controller process is capable of cycling the control loop processes F times per second. The 2^{N} time slicing algorithm recognizes that many devices can be controlled at a control frequency less than F, allowing many devices to be controlled within the bandwidth of F. The integer N determines the control resolution. For instance, if a motor operates at a control frequency of about 1000 Hz, if N=10, then the motor will be assigned a control frequency of 1024 Hz (2¹⁰=1024). If a washing machine operates at a control frequency of about 100 Hz, then it will be assigned a control frequency of 128 Hz (2^{N-3}=2¹⁰⁻³=2⁷=128). Furthermore, if a thermostat operates at about 2 cycles per second, then it will be assigned a control frequency of 2 Hz (2^{N-9}=2¹⁰⁻⁹=2¹=2).

The sum of all the control frequencies for all controlled devices must be less than F to operate in real-time. Given the above example, 1024 Hz (motor)+128 Hz (washing machine)+2 Hz (thermostat)=1154 Hz<F (5 kHz). Conventional real-time controllers function at one specified frequency. The 2^{N} time slicing algorithm allows many more devices to be controlled because the bandwidth is not being used to scan devices at a higher than necessary rate. Every process in the host device has a driver that maps the controlled device I/O and other control parameters into the 2^{N} resolution space.

After the new controlled device is assigned a control frequency at 2^{N} Hz 912, the control loop process for the new controlled device is initiated 914 between the host device and the controlled device. Programming and scheduling interfaces for the added controlled device may also be loaded as part of the managing controller process from a database of device control system-enabled devices. The managing controller process then performs 902 any control and monitoring of control loop processes for controlled devices on the device control system network.

In performing any control and monitoring 902 of control loop processes, the managing controller process specifically, and the device control system collectively, operates under a communications architecture that consists of three basic rules. The first rule is that controlled devices do not transmit on the network unless instructed to do so or unless they receive a communication from the host device. The second rule is that time is sliced into regular 2^{N} intervals to give all devices a specified fixed time to respond. And the third rule is that only controlled devices for use specifically on the device control system network may communicate on the network. These three basic rules serve to preserve real-time communication integrity of the device control system.

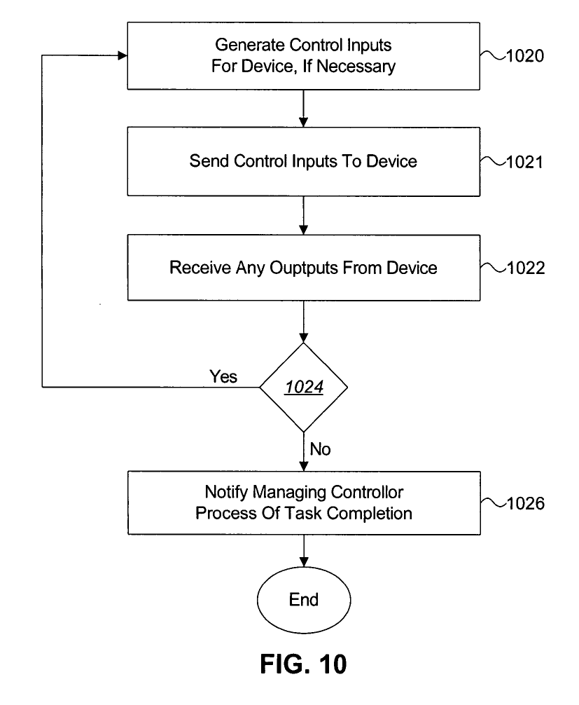

FIG. 10 is a flow diagram of a method for processing a single control loop within the managing controller process 110 as it controls one controlled device 106. The control loop process begins by generating 1020 control inputs for the controlled device if the device is running or needs to be controlled in some fashion. The control inputs could be any variety of instructions, from device start-up to shut-down, to continue performing task, to provide sensor feedback, etc. For example, the managing controller process 110 may generate control input 1020 in the form of command parameters instructing an HVAC system to start the condenser fan motor. The control inputs generated are then sent 1021 over the network to the relevant controlled device.

The control loop process then receives 1022 any output communication from the controlled device 106. Controlled device output may be in the form of feedback to indicate successful completion of the instructions/command parameters, or an error, or any other signal or data that is generated by the controlled device 106 and transmitted to the host device 104 at the request of the control loop process. Controlled devices on the device control network typically do not produce output signals on the network unless requested by the host device.

The control loop process is most often a closed control loop where control inputs are generated 1020 and the control loop process receives feedback 1022 from the controlled device. However, the device control system may also work with open control loop processes, where the control loop process generates the control input 1020 and does not receive an output signal back from the controlled device.

After receiving an output signal 1022 from the controlled device, if there is any, the control loop process then queries 1024 whether the controlled device should continue to run. If the answer to the query 1024 is positive then the control loop process again generates 1020 control inputs for the controlled device 106, if necessary. If the answer to the query 1024 is negative then the managing controller process 110 is notified 1026 of task completion, which results in terminating the control loop process for that particular controlled device. Task completion may also be coordinated with other control loop processes running on the managing controller process 110. The managing controller process may also provide notice at the graphical interface to indicate that the controlled device is shut-down or the particular task requested was completed.

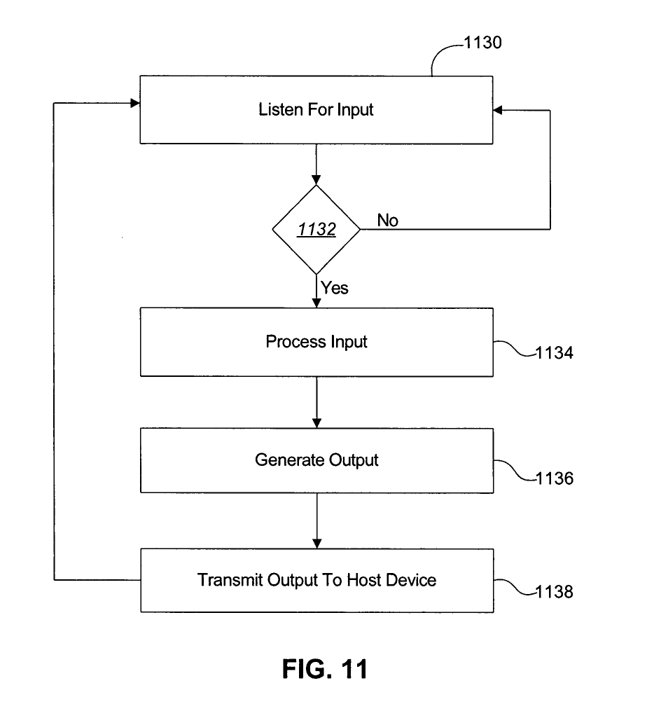

FIG. 11 is a flow diagram of a method for processing within a controlled device 106, a control loop initiated by the host device 104. The controlled device listens 1130 for control input generated by the control loop process on the host device 104. As mentioned previously, the controlled device 106 typically does not speak on the device control system network unless spoken to by the host device 104. However, the input signal that could be received by the controlled device 106 may not be directly from the host device 104. An input signal may be received from the controlled device itself, such as from a sensor or user input locally at the device.

The controlled device then determines 1132 whether a control input signal has been received. If the answer to the query 1132 is negative, the controlled device continues to listen 1130 for control input. If the answer to the query 1132 is positive, the controlled device then processes 1134 the input. Processing 1134 the control input may include performing the instructions received and acting upon the controlled device accordingly. In a closed-loop process, the controlled device then generates 1136 output. Output may be in the form of a feedback signal to the host device 104, or it may be instructions to initiate a local process, such as illuminating an LED indicator light on the controlled device itself.

After generating 1136 output, such as a feedback signal, the controlled device 106 then transmits 1138 the output to the host device 104 over the device control network. Transmission 1138 of the output signal may be over a physical transmission medium or over a wireless network as discussed previously. The controlled device then returns to listening 1130 for control input to start the method again.

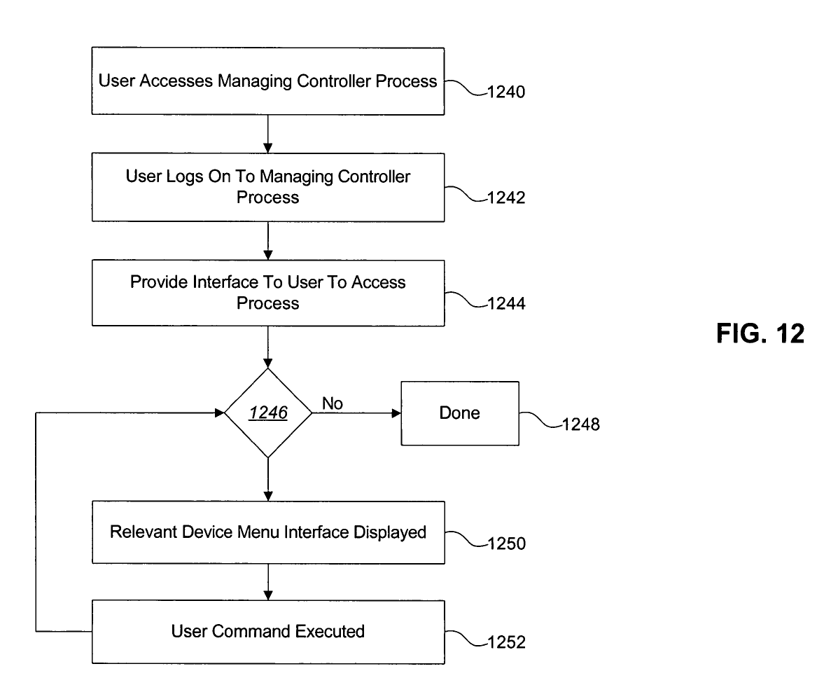

FIG. 12 is a flow diagram of a method for allowing user access to the managing controller process 110 of the host device 104. A user first accesses 1240 the managing controller process 110 through an electronic medium. Access may occur by a user initiating electronic communications at the host device 104 itself, or at a separate access point 116 on the device control system network. Additionally, access may occur by a user at a location remote from the device control system. Such access may be initiated via a remote computing device connected directly or indirectly to the Internet 118, or through a wireless connection via a web-enabled wireless device 122 such as a wireless PDA or cell phone.

Often the user may use a browser application to access 1240 the managing controller process 110 from a remote location. However, other methods of access may be employed that do not require a browser, such as Telnet or other known methods of electronic communication.

Once the user accesses 1240 the managing controller process, the user logs 1242 on to the managing controller process 110. The process of logging-on 1242 may comprise entering simple instructions to be able to monitor or control the managing control process, or it may include entering a username or a username and password.

Upon logging-on 1242 to the device control system, the managing control process 110 provides 1244 an interface to the user to access the control processes running on the system. If desired, access may be limited depending upon who the identified user is. The access to the managing controller process may provide, among other things, the ability to alter current control loop processes, re-start or shut-down other control loop processes or just monitor control loop processes running. The interface provided 1244 by the managing controller process may be a graphical interface to make the navigation of the device control system more user friendly.

The managing controller process 110 then determines 1246 whether the user wants to enter a new control or monitoring parameter. If the user does not wish to enter a new control/monitoring parameter, then the user access method is completed 1248. Completion 1248 may include, among other things, leaving the system idle or automatically logging-out the user.

If the user does want to enter a new control/monitoring parameter, the relevant device menu interface is displayed 1250. The device menu interface may be a graphical interface, such as an LCD touch screen menu that is easy to navigate, so a user having minimal technical training in computing systems will be able to perform the desired task for the relevant controlled device.

When the relevant device menu interface is displayed 1250, the user then enters the desired control/monitoring parameters and the user command is executed 1252. Execution of the user command 1252 occurs in real-time on the device control system network. Subsequent to execution of the user command 1252, the method returns to the query 1246 of whether the user wants to enter a new control or monitoring parameter.

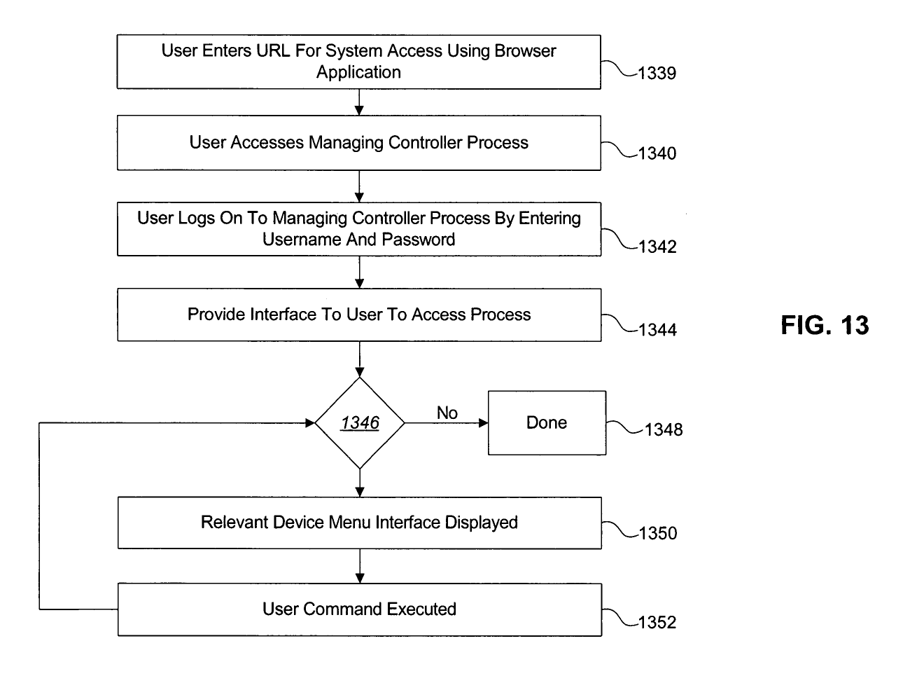

FIG. 13 is a flow diagram of one exemplary embodiment of a method for providing user access to the managing controller process 110 from a remote computing device. A user enters 1339 the Uniform Resource Locator (URL) that provides access to the host device 104 to establish electronic communications with the managing controller process 110. The URL may provide direct access to the host device 104, or it may be indirect, such as through a designated server that routes the user to the host device 104 upon entering additional identifying information. The URL is entered in a browser application, which provides the platform for electronic communications with the managing control process 110. Browser applications possess the advantages of networking and Internet communication of data, and also support common applications that can be used to speed up user interactions, such as the Flash interface application.

Upon entering 1339 the appropriate URL, the user is able to access 1340 the managing control process 110 and establish electronic communications with the host device 104. The user then logs 1342 on to the managing controller process by entering in an appropriate username and password. The step of entering the correct username and password works to prevent unauthorized access and establish a secure connection with the appropriate user.

Upon logging-on 1342 to the device control system, the managing control process provides 1344 an interface to the user to access the control process(es) running on the system, similar to the method described in conjunction with FIG. 12. Typically, the interface provided 1344 is a user-friendly graphical interface to assist in navigating the managing controller process 110.

The managing controller process 110 then determines 1346 whether the user wants to enter a new control or monitoring parameter. If the user does not wish to enter a new control/monitoring parameter, then the user access method is completed 1348.

If the user does want to enter a new control/monitoring parameter, the relevant device menu interface is displayed 1350, whereupon the user then enters the desired control/monitoring parameters and the user command is executed 1352. Execution of the user command 1352 occurs on the device control system network. Subsequent to execution of the user command 1352, the method returns to the query 1346 of whether the user wants to enter a new control or monitoring parameter.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

1. A method for controlling electronic devices through a host device, the method comprising:
establishing electronic communications between the host device and a controlled device;
assigning a control frequency for the controlled device using a 2^{N} time slicing algorithm, where N is a non-negative integer;
generating, at the host device, control input for the controlled device; and
sending the control input to the controlled device at the assigned control frequency.

2. The method of claim 1, further comprising receiving, at the host device, output from the controlled device in response to the control input.

3. The method of claim 1, wherein establishing electronic communications comprises establishing real-time electronic communications over a network.

4. The method of claim 1, further comprising establishing real-time electronic communications with a plurality of controlled devices and assigning a discrete control frequency for each controlled device using the 2^{N} time slicing algorithm, where N is a non-negative integer.

5. The method of claim 4, wherein N is independently determined for each controlled device of the plurality of the controlled devices.

6. The method of claim 1, wherein the 2^{N} time slicing algorithm comprises assigning the control frequency at 2^{N} hertz, where N is a non-negative integer that will yield a discrete control frequency in proximity to a preferred control frequency of the controlled device.

7. The method of claim 1, further comprising initiating a control loop process on the host device when electronic communication is established with a controlled device.

8. The method of claim 1, further comprising accessing the host device from a remote computing device via the Internet.

9. The method of claim 8, further comprising providing information relating to the controlled device to a user at the remote computing device.

10. The method of claim 9, further comprising receiving user input at the host device from the user at the remote computing device, wherein the input relates to the controlled device.

11. A computing device configured for controlling electronic devices, the computing device comprising:
a processor;
memory in electronic communication with the processor; and
executable instructions executable by the processor, wherein the executable instructions are configured to implement a method comprising:
establishing electronic communications between the computing device and a controlled device;
assigning a control frequency for the controlled device using a 2^{N} time slicing algorithm, wherein N is a non-negative integer;
generating, at the computing device, control input for the controlled device; and
sending the control input to the controlled device at the assigned control frequency.

12. The computing device of claim 11, wherein the method further comprises receiving, at the computing device, output from the controlled device in response to the control input.

13. The computing device of claim 11, wherein establishing electronic communications comprises establishing real-time electronic communications over a network.

14. The computing device of claim 11, wherein the method further comprises establishing real-time electronic communications with a plurality of controlled devices and assigning a discrete control frequency for each controlled device using the 2^{N} time slicing algorithm, where N is a non-negative integer.

15. The computing device of claim 14, wherein N is independently determined for each controlled device of the plurality of controlled devices.

16. The computing device of claim 11, wherein the 2^{N} time slicing algorithm comprises assigning the control frequency at 2^{N} hertz, where N is a non-negative integer that will yield a discrete control frequency in proximity to a preferred control frequency of the controlled device.

17. The computing device of claim 11, wherein the method further comprises initiating a control loop process on the computing device when electronic communication is established with a controlled device.

18. The computing device of claim 17, wherein the method further comprises initiating a torque/current control loop process at a microcontroller on the controlled device when the controlled device comprises a motor.

19. The computing device of claim 11, wherein the method further comprises accessing the computing device from a remote computing device via the Internet.

20. The computing device of claim 19, wherein the method further comprises providing information relating to the controlled device to a user at the remote computing device.

21. The computing device of claim 20, wherein the method further comprises receiving user input at the computing device from the user at the remote computing device, wherein the input relates to the controlled device.

22. A computer-readable medium for storing program data, wherein the program data comprises executable instructions for implementing a method in a computing device for controlling electronic devices, the method comprising:
establishing electronic communications between the computing device and a controlled device;
assigning a control frequency for the controlled device using a 2^{N} time slicing algorithm, where N is a non-negative integer;
generating, at the computing device, control input for the controlled device; and
sending the control input to the controlled device at the assigned control frequency.

23. The computer-readable medium of claim 22, wherein the method further comprises receiving, at the computing device, output from the controlled device in response to the control input.

24. The computer-readable medium of claim 22, wherein establishing electronic communications comprises establishing real-time electronic communications over a network.

25. The computer-readable medium of claim 22, wherein the method further comprises establishing real-time electronic communications with a plurality of controlled devices and assigning a discrete control frequency for each controlled device using the 2^{N} time slicing algorithm, where N is a non-negative integer.

26. The computer-readable medium of claim 25, wherein N is independently determined for each controlled device of the plurality of controlled devices.

27. The computer-readable medium of claim 22, wherein the 2^{N} time slicing algorithm comprises assigning the control frequency at 2^{N} hertz, where N is a non-negative integer that will yield a discrete control frequency in proximity to a preferred control frequency of the controlled device.

28. The computer-readable medium of claim 22, wherein the method further comprises initiating a control loop process on the computing device when electronic communication is established with a controlled device.

29. The computer-readable medium of claim 22, wherein the method further comprises accessing the computing device from a remote computing device via the Internet.

30. The computer-readable medium of claim 29, wherein the method further comprises providing information relating to the controlled device to a user at the remote computing device.

31. The computer-readable medium of claim 30, wherein the method further comprises receiving user input at the computing device from the user at the remote computing device, wherein the input relates to the controlled device.
